(19) United States
(12) Patent Application Publication
(10) Pub. No.: US 2011/0062302 A1
(43) Pub. Date: Mar. 17, 2011

(54) CLASP WITH LOCKING FUNCTION

(75) Inventor: Hak Soon Choi, Kyunggi-do (KR)

(73) Assignees: Hak Soon CHOI, Bucheon-si, Kyunggi-do (KR); Jae Heung LEE, Seoul (KR)

(21) Appl. No.: 12/993,816

(22) PCT Filed: Feb. 11, 2009
(86) PCT No.: PCT/KR2009/000654

§ 371 Date: Nov. 19, 2010

(30) Foreign Application Priority Data
May 20, 2008 (KR) 10-2008-0046725

(51) Int. Cl. F16B 2/20

(52) U.S. Cl. 248/316.7

(57) ABSTRACT

The present invention relates to a clasp with a locking function to prevent losing portable items such as mobile phones, walkie-talkies, PDAs, and MP3s. To overcome the problems of conventional clasps which are easily released while being carried when a force is exerted on them in a certain direction, and with which portable items that are coupled to carrying mounts and worn on the body of a user are frequently lost because the clasp becomes disengaged while the user is using public transportation densely packed with people or walking, the present invention proposes a clasp with a locking function, which includes a fixing member fixedly coupled to the coupling part of a mount, and a clip pivotably coupled to the fixing member by a rotational axis. The fixing member (10) comprises a pair of first supports (12) spaced apart from each other and provided with an axis hole (13) at one end; the clip (30) comprises a pair of second supports (32) spaced apart from each other and provided at one end with an elongated hole (33), a rotational space (34), and an insertion part (35), and the clip (30) receives upward resilient bias from a leaf spring (21) and is rendered pivotable on the fixing member (10) through corresponding coupling of the first supports (12) and the second supports (32); the rotational axis (20) is moved toward a lower portion of the elongated hole (33) by resilient support of the leaf spring (21); and a projecting part (14), extending from an outer surface of the axis hole (13) is inserted in the insertion part (35) opening to one side of the rotational space (34) to prevent the clip (30) from pivoting. Thus, according to the present invention, the projecting part (14) of the fixing member (10) is inserted and fixed in the insertion part (35) of the clip (30) and hence the clasp is not released when external force is applied, and loss of portable items can be prevented.

### TECHNICAL FIELD

The present invention relates to portable clasp, in more detail, a clasp with a locking function of preventing loss of portable products, such as mobile phones, walkie-talkies, PDAs, and MP3 players.

### BACKGROUND ART

In general, portable electronic products, such as mobile phones, walkie-talkies, PDAs, and MP3 players, can be carried by portable carrying mounts on the body, and clasps that can be fixed to the belt or pockets are attached on the rear of the carrying mounts.

The clasps of the related art are easily unlocked by force applied in predetermined directions, such that people with portable products in the clasps on their bodies frequently lose the portable products due to the unlocking of the clasps while using the public transportation or walking.

### DISCLOSURE

### Technical Problem

The present invention has been made in an effort to solve the problems and it is an object of the present invention to provide a clasp with a locking function which is not unlocked and prevents possibility of loss of portable products, even if force is applied in a predetermined direction.

### Technical Solution

The present invention provides a clasp with a locking function, which includes: a fixing member fixed to a coupling part of a mount, and a clip pivotably coupled to the fixing member by a rotary shaft, in which the fixing member has a pair of first supports having shaft holes and spaced apart from each other at one side, the clip has a pair of second supports having elongated holes and a rotational spaces and spaced apart from each other, such that the first supports and the second supports are coupled to allow the clip to pivot about the fixing member by means of upward elasticity of a leaf spring, the rotary shaft is moved down in the elongated holes by elastic support of the leaf spring, and protrusions extending outward around the shaft holes are inserted in insertion parts formed to be open at a side of the rotational spaces, thereby preventing the clip from pivoting.

### ADVANTAGEOUS EFFECT

According to a clasp with a locking function of the present invention, the protrusions 14 of the fixing member 10 are inserted and fixed in the insertion parts 35 of the clip 30, such that the clasp is not unlocked, even if external force is applied, thereby preventing loss of portable products.

Further, as the upper end of the clip 30 is pressed, the leaf spring 21 is compressed and the rotary shaft 20 is moved upward in the elongated holes 33, such that the protrusions 14 are separated from the insertion part 35 into the rotational spaces 34, thereby making it easy to unlock the clasp.

### BRIEF DESCRIPTION OF DRAWINGS

FIG. 1 is an exploded perspective view showing a clasp with a locking function according to the present invention.

FIG. 2 is a cross-sectional view taken along the line II-II of FIG. 1.

FIG. 3 is a plan view showing an example of a clasp with a locking function according to the present invention.

FIG. 4 is a partial enlarged view and a cross-sectional view taken along the line IV-IV of FIG. 3.

FIG. 5 is a cross-sectional view and an enlarged view when the clasp of the present invention is unlocked.

FIG. 6 is a side view showing a first embodiment of the present invention.

FIG. 7 is a side view showing a second embodiment of the present invention.

FIG. 8 is a side view showing a third embodiment of the present invention.

### REFERENCE NUMERALS

| | |
|---|---|
| 4, 5: Hook | 10: Fixing member |
| 11: Rail | 12: First support |
| 13, 53: Shaft hole | 14, 54: Protrusion |
| 20: Rotary shaft | 21: Leaf spring |
| 30, 40: Clip | 31, 41: Bend |
| 32: Second support | 33, 63: Elongated hole |
| 34, 64: Rotational space | |
| 35, 65: Insertion part | |
| 50: Lower clip | 51, 61: Contact portion |
| 52: Lower support | |
| 60: Upper clip | 62: Upper support |

### BEST MODE

A clasp with a locking function according to the present invention includes: a fixing member fixed to a coupling part of a mount, and a clip pivotably coupled to the fixing member by a rotary shaft, in which the fixing member has a pair of first supports having shaft holes and spaced apart from each other at one side, the clip has a pair of second supports having elongated holes and a rotational spaces and spaced apart from each other, such that the first supports and the second supports are coupled to allow the clip to pivot about the fixing member by means of upward elasticity of a leaf spring, the rotary shaft is moved down in the elongated holes by elastic support of the leaf spring, and protrusions extending outward around the shaft holes are inserted in insertion parts formed to be open at a side of the rotational spaces, thereby preventing the clip from pivoting.

### MODE FOR INVENTION

Preferred embodiments of the present invention are described in detail with reference to the accompanying drawings.

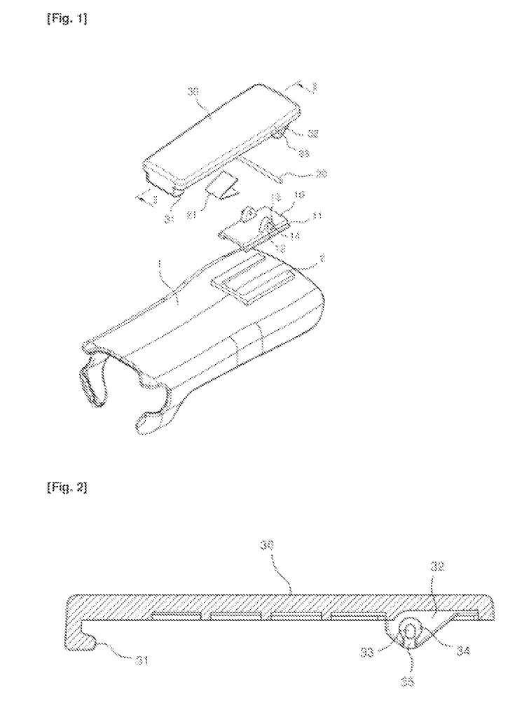

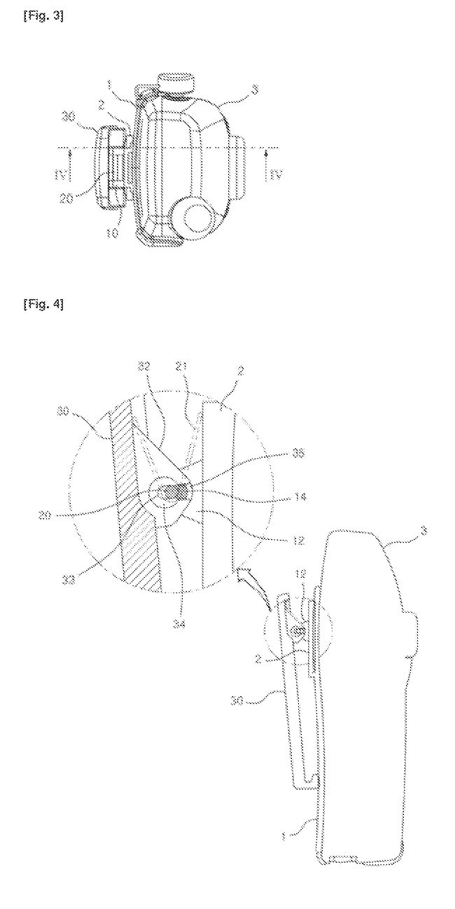

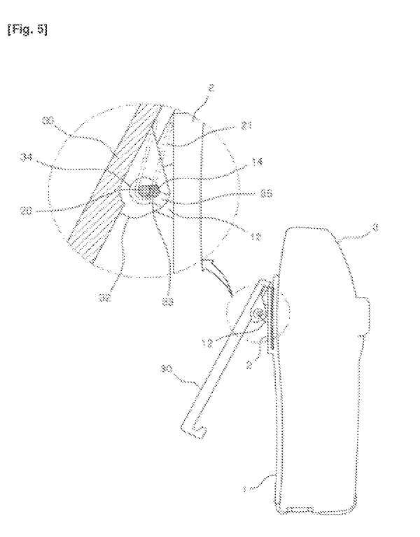

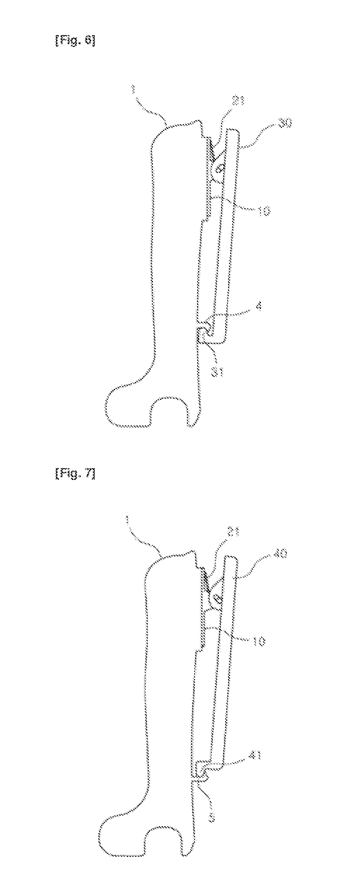

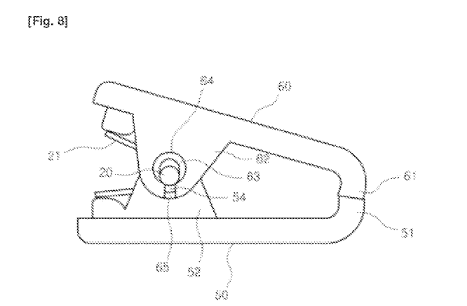

FIG. 1 is an exploded perspective view showing a clasp with a locking function according to the present invention, FIG. 2 is a cross-sectional view taken along the line II-II of FIG. 1, FIG. 3 is a plan view showing an example of a clasp with a locking function according to the present invention, FIG. 4 is a partial enlarged view and a cross-sectional view taken along the line IV-IV of FIG. 3, FIG. 5 is a cross-sectional view and an enlarged view when the clasp of the present invention is unlocked, FIG. 6 is a side view showing a first embodiment of the present invention, FIG. 7 is a side view showing a second embodiment of the present invention, and FIG. 8 is a side view showing a third embodiment of the present invention.

As shown in FIG. 1, the clasp with a locking function of the present invention can be coupled to a mount 1 such that users can carry portable products on their bodies, such as mobile phones, walkie-talkies, PDAs, and MP3 players.

A coupling part 2 is formed on the rear of the mount 1, such that the clasp of the present invention is coupled thereto to be put on a belt or in pockets of cloth. The clasp is composed of a fixing member 10 fixed to the coupling part 2 and a clip 30 pivotably coupled to the fixing member 10.

Rails 11 are formed at both sides of the fixing member 10 to be inserted in the coupling part 2, a pair of first supports 12 is spaced apart on the upper surface, and shaft holes 13 where a rotary shaft 20 is inserted are formed through the first supports 12.

Further, a protrusion 14 having a predetermined length is formed outward around the shaft hole 13, that is, protrusions 14 are symmetrically formed at the two first supports 12.

Meanwhile, as shown in FIG. 7, the rotary shaft 20 is inserted in the shaft holes 13, a clip 30 is pivotably coupled to both ends of the rotary shaft 20, and a bend 41 that is in close contact with the rear of the mount 1 is formed at the front end of the clip 30.

Further, a pair of second supports 32 with elongated holes 33 where the rotary shaft 20 is inserted is spaced apart from each other at one side on the bottom of the clip 30 and a rotational space 32 communicating with the elongated hole 33 is formed inward on the inner surface of the second support 32, as shown in FIG. 2.

Further, an insertion part 35 is formed at a side of the outer circumference of the rotational space 34 and a leaf spring 21 is disposed between the fixing member 10 and the clip 30 having the configuration described above to always apply elastic force upward.

The clasp with a locking function of the present invention having the configuration described above, as shown in FIG. 3, can be coupled with the mount 1 to carry a walkie-talkie 3 etc. The upper end is moved up by the leaf spring 21 and the bend 31 at the lower rend is in close contact with the mount 1 to be put on a belt of a pocket of cloth, in a normal state, as shown in FIG. 4.

Since the upper end of the clip 30 has been moved up by the elastic force of the leaf spring 21, the rotary shaft 20 is positioned at the lower portion (at the right in the figure) in the elongated hole 33 and the protrusion 13 is correspondingly inserted in the insertion part 35 and prevents the clip 30 from pivoting.

Therefore, the clip 30 does not pivot and prevents the claps from separating from the body, even if external force is applied to the mount 1 with the walkie-talkie 3.

On the contrary, when a user presses the upper end of the clip 30, as shown in FIG. 5, in order to detach the clasp from the body, the leaf spring 21 is compressed and the rotary shaft 20 moves upward (left in the figure) in the elongated hole 33, such that the protrusion 14 is separated from the insertion part 35 into the rotational space 34.

Further, as the clip 30 pivots on the rotary shaft 20, the protrusion 14 rotates in the rotational space 34, and when the user takes off the hand pressing the clip 30, the upper end is returned by the elastic force of the leaf spring and the protrusion 14 is inserted in the insertion part 35.

Further, according to another embodiment of the present invention, as shown in FIG. 6, a hook 4 may be formed at the lower portion of the rear of the mount 1 such that the clasp can be locked by locking the bend 31 of the clip 30 to the hook 4.

Further, a hook 5 may be formed in the opposite direction, in which the bend 31 is also formed in the opposite direction to be locked.

On the other hand, as shown in FIG. 8, the clasp may be composed of a lower clip 50 and an upper clip 60 having contact portions 51, 61 to attach/detach the body, and the basic structure and operation are the same as those in FIG. 4.

That is, the lower clip 50 has a pair of lower supports 52 having shaft holes 53 where the rotary shaft 20 inserted and protrusions 54 are formed outward around the shaft holes 53 to correspond to the fixing member 10 shown in FIG. 10.

Further, the upper clip 60 has a pair of upper supports 62 spaced apart from each other and having elongated holes 63 where the rotary shaft 20 is inserted, a rotational space 64 is formed on the inner sides of the upper supports 62 such that the protrusion 54 is rotatably inserted, and an insertion part 55 where the protrusion 54 is inserted and fixed is formed to be open at a side of the rotational space 64.

In this case, the upper clip 60 is elastically combined with the upper side by a leap spring 21, such that it corresponds to the clip 30 of FIG. 4.

Therefore, the rotary shaft 20 inserted through the shaft holes 53 and the elongated holes 63 is moved down in the elongated holes 63 by elastic support of the leaf spring 21 and the protrusion 54 is inserted in the insertion part 55, thereby preventing the upper clip 60 from pivoting.

The present invention is not limited to the embodiments described above and may be modified in various ways by those skilled in the art, without being deviate from the scope of the present invention, which is described in the following claims.

### INDUSTRIAL APPLICABILITY

The clasp with a locking function according to the present invention is coupled with the mount 1 to carry a walkie-talkie 3 etc, in which the upper end of the clip 30 is moved up in the leaf spring 21 and the bend 31 at the lower end is in closed contact with the mount 1 to be attached to a belt or a pocket of cloth, in a normal state, while the protrusion 14 of the locking member 10 is inserted and fixed in the insertion part 35 of the clip 30 when the clasp is locked. Therefore, the clasp is not unlocked, even if external force is applied, such that it is possible to loss of the portable produce and to expect high industrial applicability.

1. A clasp with a locking function comprising:
a fixing member fixed to a coupling part of a mount; and
a clip pivotably coupled to the fixing member by a rotary shaft,
wherein the fixing member 10 has a pair of first supports 12 having shaft holes 13 and spaced apart from each other at one side, the clip 30 has a pair of second supports 32 having elongated holes 33 and a rotational spaces and spaced apart from each other, such that the first supports 12 and the second supports 32 are coupled to allow the clip 30 to pivot about the fixing member 10 by means of upward elasticity of a leaf spring 21, the rotary shaft 20 is moved down in the elongated holes 33 by elastic support of the leaf spring 21, and protrusions 14 extending outward around the shaft holes 13 are inserted in insertion parts 35 formed to be open at a side of the rotational spaces 34, thereby preventing the clip 30 from pivoting.

2. The clasp with a locking function according to claim 1, wherein the fixing member 10 has rails 11 at both sides to be inserted in the coupling part 2, and the clip 30 has bends 31, 41 that bend upward or downward at the front end which are locked to hooks 4, 5 bending upward or downward at the mount 1.

3. A clasp with a locking function which is composed of a lower clip and an upper clip with a leaf spring therebetween to provide elastic force,
wherein the lower clip 50 has a pair of lower supports 52 having shaft holes 53 and spaced apart from each other, protrusions 54 are formed outward around the shaft holes 53, the upper clip 60 has a pair of upper supports 62 having elongated holes 63 and spaced apart from each other, rotational spaces 64 are formed on the inner sides of the upper supports 62 such that the protrusions 54 rotates therein, the rotational space 64 is open to one side to form an insertion part 65, the rotary shaft 20 inserted through the shaft holes 53 and the elongated holes 63 are moved down in the elongated holes 63 by elastic support of a leaf spring 21, and the protrusions 54 are inserted in the insertion part 65, thereby preventing the upper clip 60 from pivoting.
